(19) United States
(12) Patent Application Publication
(10) Pub. No.: US 2016/0219339 A1
(43) Pub. Date: Jul. 28, 2016

(54) System and Method for Interacting with Video Comments Through Social Networking Sites

(71) Applicant: Ronelle Brockington, Florence, SC (US)

(72) Inventor: Ronelle Brockington, Florence, SC (US)

(21) Appl. No.: 14/603,798

(22) Filed: Jan. 23, 2015

(51) Int. Cl. H04N 21/4788; H04N 21/2743; H04N 21/475; H04N 21/258

(52) U.S. Cl. CPC H04N 21/4788; H04N 21/25866; H04N 21/2743; H04N 21/4753

(57) ABSTRACT

A method and system for allowing the user to post video accompanying video comments comprises a serve coupled with a memory unit integrated with a database module. The database module maintains the information regarding at least one video created by the user. The system allows the user to record and upload the at least one video and video comment to a web based interface. The web based interface allows the user to maintain a login account and a profile video. The system allows the user to flip the camera from a front view to a back view while recording, and turn a light on/off while recording.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE DISCLOSURE

The present invention relates to video social networking sites, more particularly to a web-based video system with accompanying video comments.

### DISCUSSION OF RELATED ART

The posting and uploading at least one video on websites has developed into a worldwide phenomenon. Current video systems provide video to a video sharing system of one or more computers. Other users can then view at least one video by downloading or streaming at least one video from the video sharing system to a user system. The video sharing environment can support video sharing accounts. To access a video sharing account, a user normally supplies a name and login credentials. Once authenticated, account owners can upload video, access video and share video along with managing the account. Account owners can also view comments from viewers related to their videos. However, this video system does not allow the user to record and upload the videos by flipping the camera from the back view to the front view to take the videos to the site while recording. Moreover, the system needs a webcam to record and uploads the videos.

An existing video system comprises a video tagging system allowing the users to interact with the video content. The video staging system also includes a tag information database maintaining information regarding tags created by users. The interface includes a video player upon which video content is displayed as a video and a tag display presenting tags associated with the video. However, this system does not allow the user to record and upload the videos to the website.

In a known prior art related to video-sharing of contents, includes computer programs encoded on a computer storage medium for linking video sharing accounts with content delivery accounts, the control includes a tool for linking a content delivery account associated with a user in the content delivery system with one or more video sharing accounts in a video sharing environment. However, such a system does not allow a user to create profile videos that provide a dynamic, interactive experience for site visitors/followers. Moreover, such a system does not have an option to create profile video to encourage users to spend more time on the web page and thereby decreasing stickiness and revenues.

An existing video system comprises the video segment to be shared over a computer network by first receiving the video segment. The receiving computer assures that the video segment is in a streaming video format, and creates at least one identification tag for the video segment. The receiving computer also stores the video segment, and communicates the identification tag to another computer on the network. Upon subsequent receipt of the identification tag, the receiving computer streams the video segment to a destination computer on the network. However, this video system does not allow the user to record and upload the video comments.

Therefore, there is a need for an improved video social networking site that allows the user to post and upload videos directly to other social networking sites. Such a needed system would allow the user to record and upload videos having a customized/predetermined period of time, to the site. Such a needed system would allow the user o flip the camera from a front view to a back view and turn light on/off while recording. Further, such a needed system would provide the user with the capability to create profile video that allows other followers to get descriptions of every other user. Furthermore, such a system would allow the user to post video comments. Finally such a system would be compatible with all smart phones, tablets, laptops, like devices. The present invention accomplishes these objectives.

### SUMMARY OF THE DISCLOSURE

The present embodiment is a method and system for allowing a user to post video accompanying video comments comprises a server coupled with a memory unit integrated with a database module that maintains the information regarding at least one video created by the user. A web based interface that allows the users to interact with the video, the web based interface maintains a login account and a profile video created by the user. The system allows the user to record and upload videos having a customized/predetermined period of time, to the site. The system allows the user to flip the camera from a front view to a back view while recording, and turn a light on/off while recording.

The present invention discusses in detail after logging into they system. The user will be able to view at least one video in the home page where the other users are following. The home page including a toolbar which includes a search, a record, my video, a profile, and settings where the previous at least one video will be visible to users. The user is able to view all likes and reflip particular video during the time posting. The web based interface is selected from the group consisting of: a personal computer, a desktop computer, a laptop computer, a pad or tablet computer, and a smart phone.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 illustrates a block diagram of a system in accordance with a preferred embodiment of the present invention;

FIG. 2 illustrates a screenshot of a landing page in accordance with a preferred embodiment of the present invention;

FIG. 3 illustrates a screen shot of a home page in accordance with a preferred embodiment of the present invention;

FIG. 4 illustrates a screen shot of a search in accordance with a preferred embodiment of the present invention;

FIG. 5 illustrates a screen shot of a record in accordance with a preferred embodiment of the present invention,

FIG. 6A and 6B illustrate a screen shot of my video in accordance with a preferred embodiment of the present invention;

FIG. 7 illustrates a screen shot of a profile in accordance with a preferred embodiment of the present invention;

FIG. 8 illustrates a screen shot of a setting in accordance with a preferred embodiment of the present invention;

FIG. 9A through 9E illustrate a screen shot of an administrator user in accordance with a preferred embodiment of the present invention; and

FIG. 10 shows a flowchart off method 200 for allowing the user actively manage a video in accordance with a preferred embodiment of the present invention.

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way. Among other things, the following invention may be embodied as methods or devices. As such, the present invention may take the form of an entirely hardware embodiment, an entirely software embodiment, or an embodiment combining software and hardware aspects. The following detailed descriptions should not be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

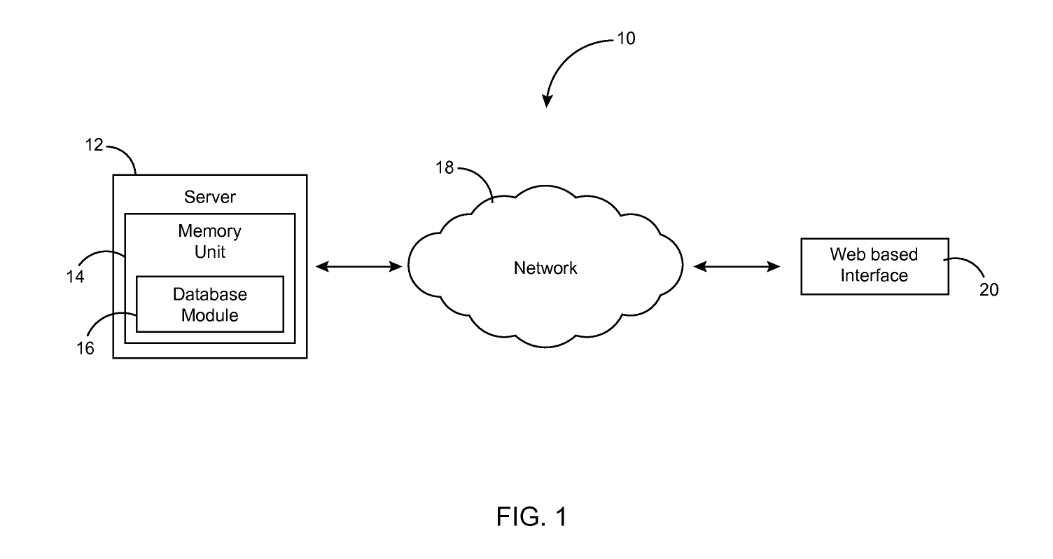

FIG. 1 illustrates a block diagram of a system 10 in accordance with a preferred embodiment of the present invention. The system 10 that allows a user to post video accompanying video comments comprises a server 12 coupled with a memory unit 14 integrated with a database module 16 that maintains the information regarding at least one video created by the user. A web based interface 20 allows the users to interact with the video through a network 18. The web based interface 20 maintains a login account and a profile video created by the user. The system 10 allows the user to record and upload videos having a customized/predetermined period of time, to a website. The system 10 allows the user to flip the camera from a front view to a back view while recording, and turn a light on/off while recording.

The present invention discusses in detail after logging into the system 10. The user will be able to view at least one video in the home page where the other users are following. The home page including a toolbar which includes a search, a record, my video, a profile, and settings where the previous video will be visible to the users. The user is able to view all likes and reflip particular video during the time of posting.

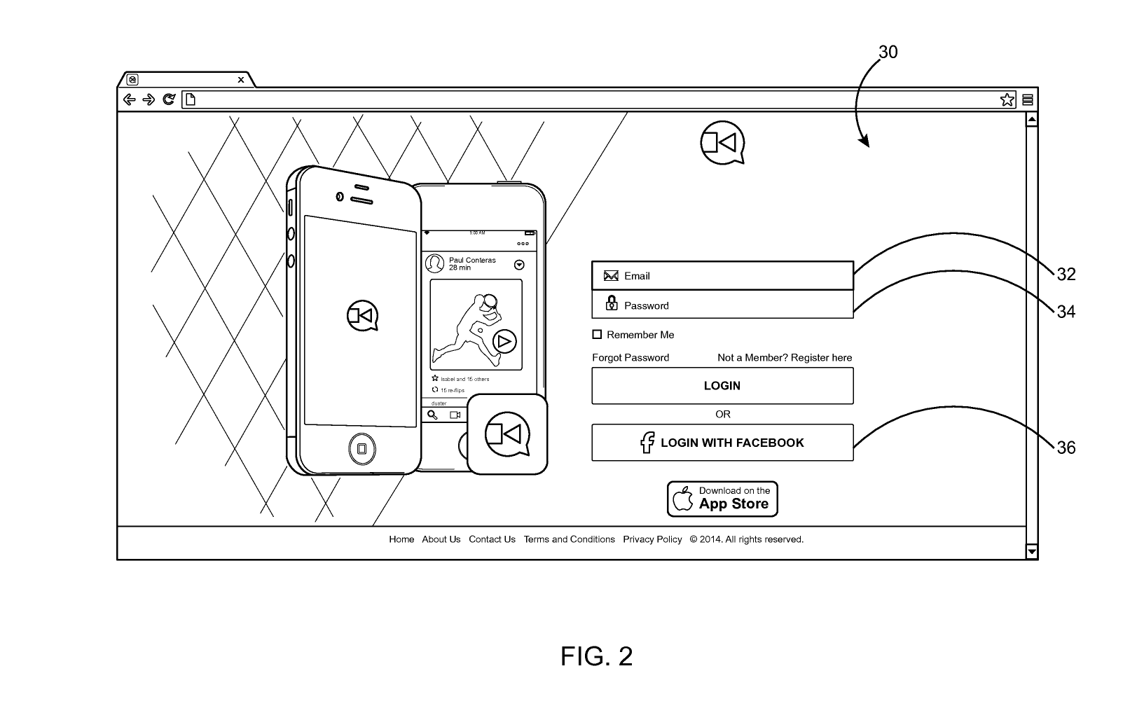

Referring to FIG. 2, a screenshot of a landing page 30 of the website in accordance with a preferred embodiment of the present invention is illustrated. The landing page 30 includes login options and a new popup or new page will be opened when the user clicks on it.
STEP 1: The user logs into Facebook™ 36 or website: The user will login with Facebook 36 or website utilizing a Username, for example, Email 32 and a Password 34.
STEP 2: Register: The user has to register on web based interface for login into account and utilize the features at least one video for editing and sharing etc.
STEP 3: Forget Password: User will be asked for registered email address or username. If that email or username exists, an email will be sent on email address with the change password link.
STEP 4: Signup form: Initial fields will be name full name, username, email 32, and password 34. In edit profile, there will be more fields like change name, profile video etc. An activation email will be sent to registered email address which will contain an activation link and have an expiration date of three days. To activate account, the user needs to open this link within three days, if the link is not opened within three days, account will be terminated and the user may need to register again.

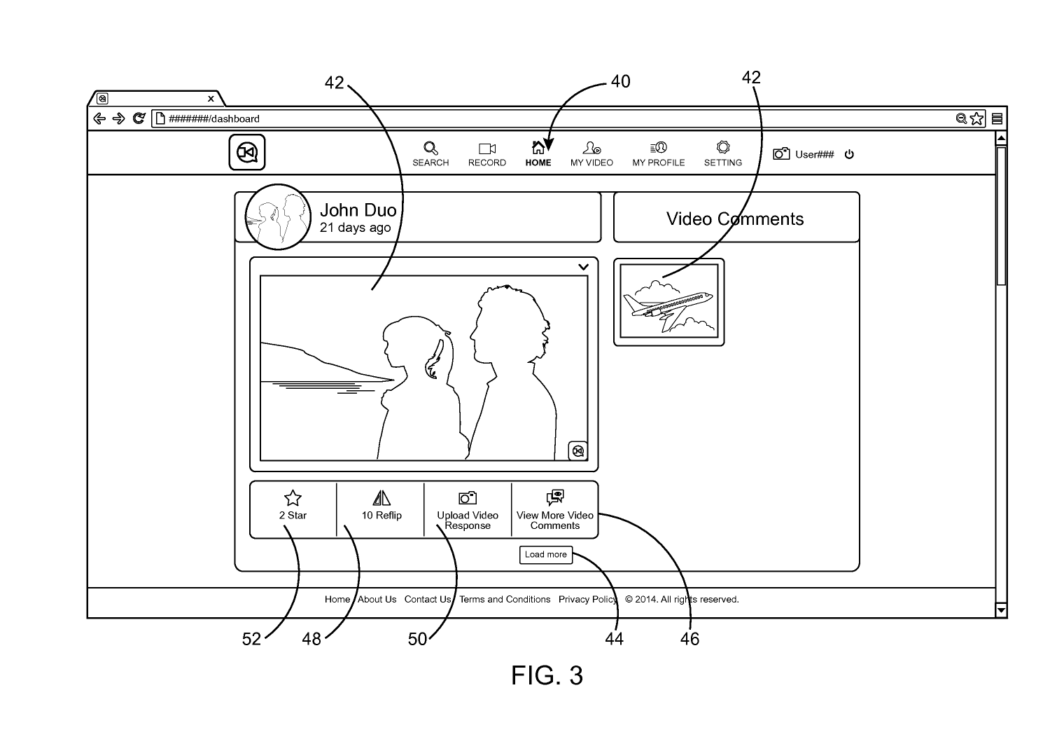

FIG. 3 illustrates a screen shot of a home page 40 in accordance with the preferred embodiment of the present invention. After logging into the web based interface 20 the user will be able to view at least one video 42 in the home page 40 where the other users are following. To view more videos 42 then the user is required to click on load more 44, to view previous videos 42 and video comments 46. The user is able to view all likes and reflip 48 particular video during the time of posting. The system 10 allows the user to like the at least one video 42 to reflip 48 i.e. share those video via Facebook, Twitter etc. The system 10 allows the user to post video 42 responses for any post of the users which they are following.

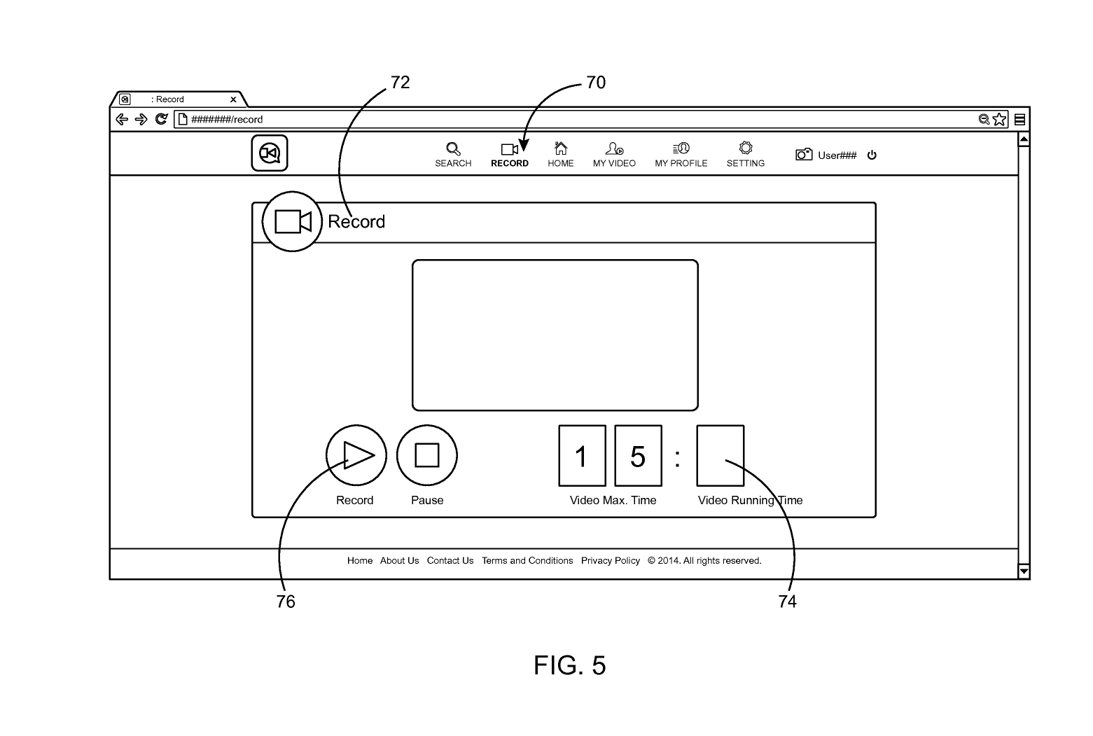

The users are able to view the uploaded video comments 50 in the system 10 and click on ‘view comments’ to redirect the page wherein all comments will be visible to the user for particular video. The web based interface 20 having an option for choosing at least one video or record video (See. FIG. 5). The system 10 allows the user to post a video comment 26 by clicking the video comment 26. The system 10 allows the user to follow the list by logged in with video thumb, video name, likes count, reflip count, followed by count, responses count. Once the user clicks on the video 42, the user can view that the video 42 and also view all the responses of the at least one video 42. The home page 40 allows the user to like, or reflip 48 the at least one video 42. The home page 40 allows the user to post/upload response to the at least one video 42. The number of likes will be represented using star icon to show the at least one video 42. If a minimum of three users report/spam to the at least one video 42, then it would be automatically deleted from the network. The number of likes will be represented using star icon 52 to show on the video 42.

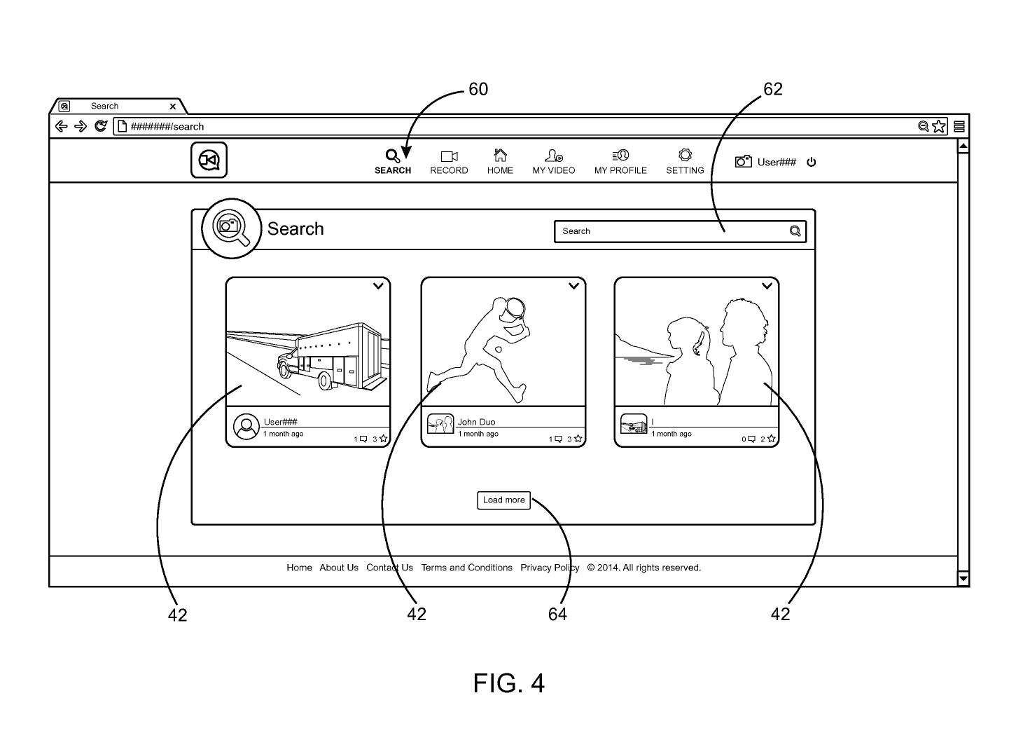

FIG. 4 illustrates a screen shot of a search 60 in accordance with the preferred embodiment of the present invention. The search 60 screen allows the user to search 60 for the other users/followers. Below the search bar 62, there will be a list of highest ranked top twenty videos of the day visible in this module. All the videos 42 will be listed as username and the video 42 of particular user which is more liked by others. The at least one video 42 will be listed in chronological order. The system 10 allows the user to click on the username to redirect the user's profile. The user can view all the details and follow him by clicking at least one video 42. The system 10 allows the user to block and view the particular video 42. The search 60 screen allows the user to search the top twenty video 42. The screen for search 42 allows the user to search at least one video by clicking the option such as name, category or video name. To view more videos 42 then click on load more 64 to view the previous video 42.

FIG. 5 illustrates a screen shot of a record 70 in accordance with the preferred embodiment of the present invention. The user will have a webcam to record 72 the video 42 otherwise, alert will display. The system 10 is configured to record 72 the video 42 in dark. The video 42 will be recorded for, preferably 15 seconds 74. The system 10 allows the user to preview the recorded video 76. The recorded video 76 automatically saved and visible on ‘My video’. Before sharing the video 42 the system 10 allows the user to add tag or category to that particular video 42.

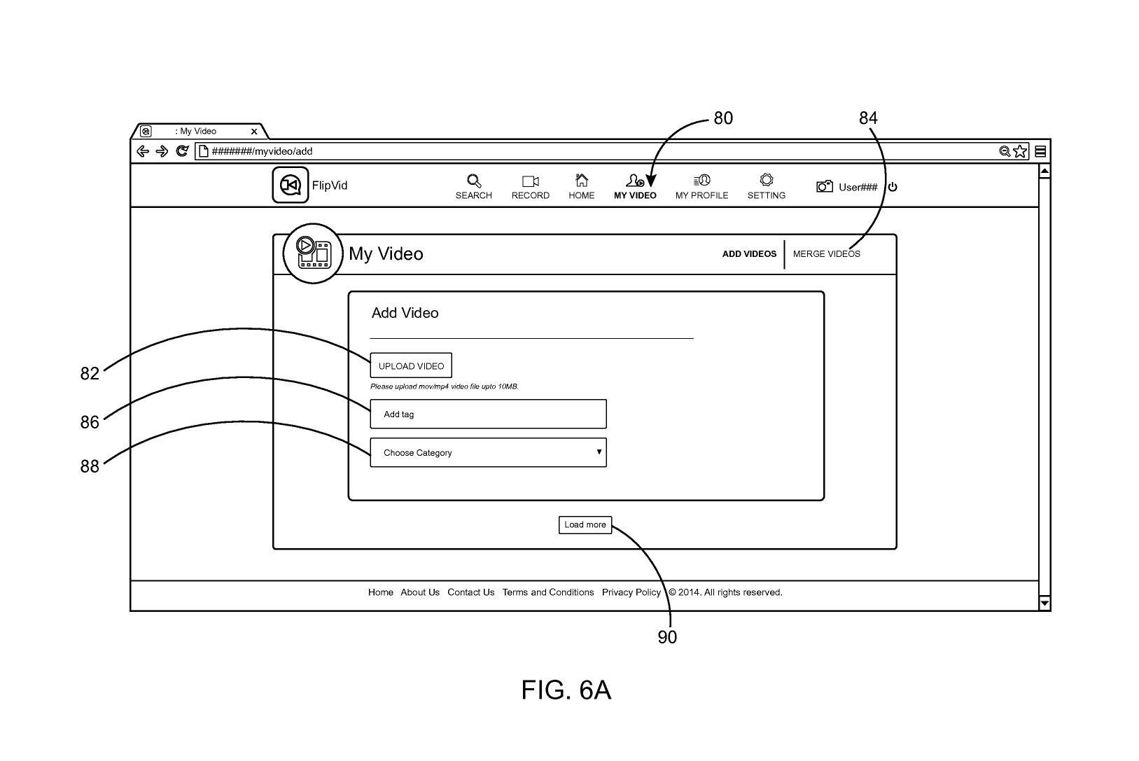

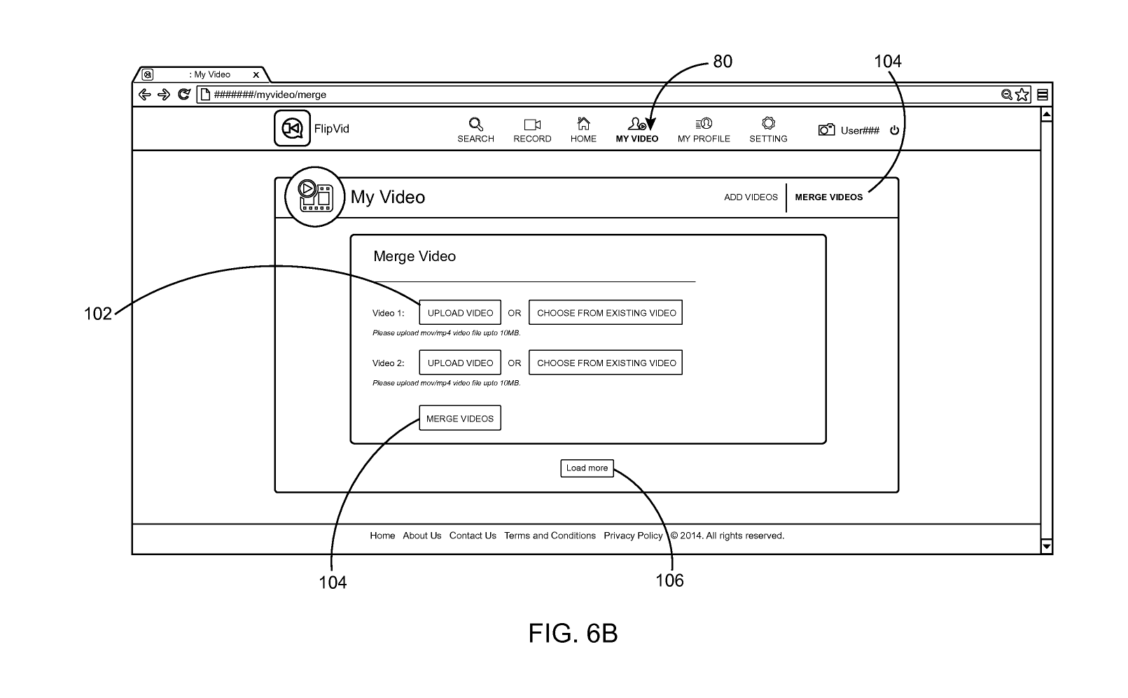

FIGS. 6A and 6B illustrate a screen shot of my video 80 in accordance with a preferred embodiment of the present invention. The system 10 allows the user to view all the videos 42 through a mobile app and from local drive utilizing a button “upload video” 82. The system 10 is compatible with iOS devices and not more than 15 seconds. All the videos 42 will be visible on this screen and the user can select the at least one video 42 to perform operations such as: Add Music, Trim video, Merge two video 84, Add Effects/Filters to video 42. After editing the user can add tag 86 or choose category 88 for specific video to save. To view more video 42 then click on load more 90 to view the previous video 42.

The at least one video 42 would be saved and redirect to publish page. The system 10 allows the user to share it on social networking sites or cancel it. The system 10 allows the user to perform operations on the video 42 like add music, trim video, merge video, and add filters. The web base interface 20 is configured with add music, trim, merge or add filters etc. After performing operation the user can preview cancel the operation. The system 10 is configured to save and publish that video 42. The system 10 allows the user to share at least one video 42 on Facebook and twitter. The system 10 is configured to view at least one video 42 for 15 seconds, if it's more than 15 seconds then the system 10 will automatically trim it for first 15 seconds. The system 10 is riot configured to upload more than 100 MB video 42.

Further, the system 10 is configured with add music that allows the user to add music from local library of PC or laptop. The at least one video 42 selected by the user should be of 15 seconds only. The system 10 allows the user to select at least one video 42 from a drive. Once click on add music there will be an option to upload MP3 music from local library. The system 10 allows the user to save the final video or publish it.

Furthermore, the system 10 configured with trim video, which allows the user to trim the video 42 in required size. The system 10 configured to select the at least one video 42 to trim from list or upload the at least one video 42 from a local drive. The system 10 allows the user to preview the video 42 and the phase time. The system 10 allows the user to save at least one video 42 and add on to category. Typically the user can publish the video 42 once they perform operation.

Moreover, the system 10 is configured with the merge video 84 that allows the user to edit the at least one video 42 such as merge it. i.e. the user can merge two video of 15+15 seconds. The system 10 allows the user to select the at least one video 42 from a list. The system 10 allows the user to access merge tab to merge two videos 84. After merging the at least one video 42 will move to add category 88 or tag 86. The user is responsible to publish or save the video. Finally, the system 10 is configured with add filters/effects to the at least one video 42. The system 10 is configured to select the effects of the at least one video 42 and save it.

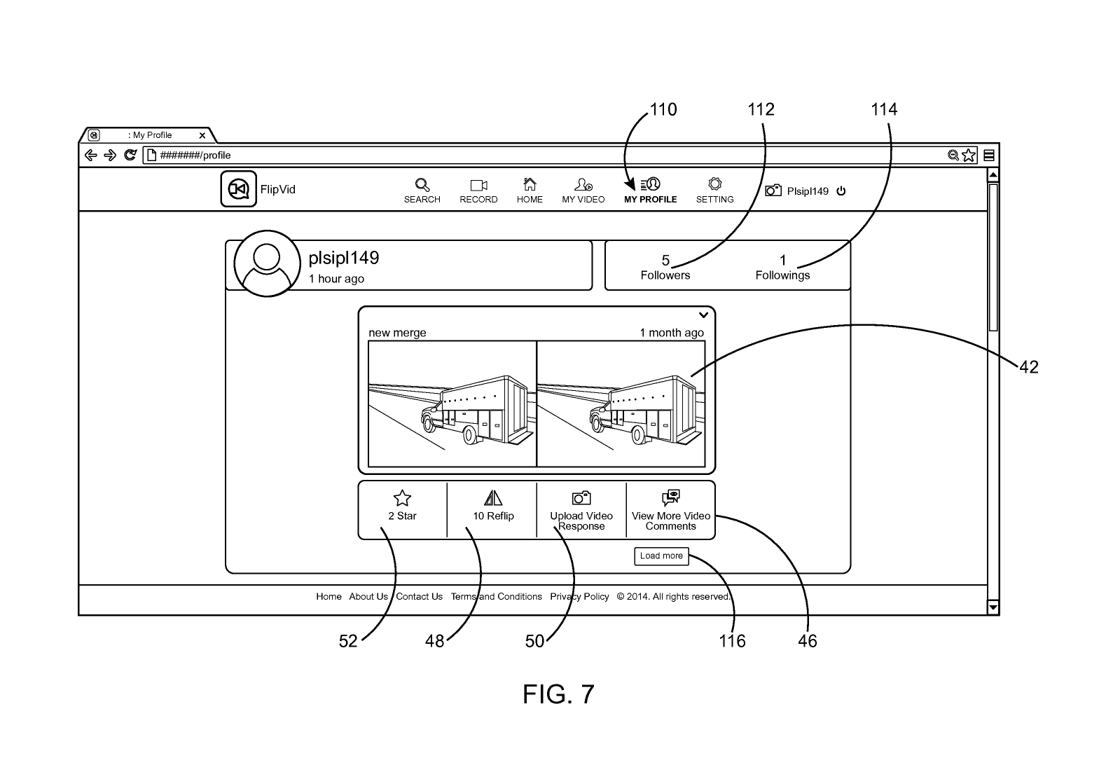

FIG. 7 illustrates a screen shot of a profile 110 in accordance with the preferred embodiment of the present invention. The profile 110 allows the user to view their profile 110. The module/navigation configured in the profile 110 allows the user to view the at least one video 42 posted by followers. The at least one video 42 will be visible as per the latest updating of the user. The profile 110 includes the ‘follow tab’ that allows the users to follow/unfollow the users. The system 10 allows the user to view video comments 46 posted by the followers. The user can like and re lip 48 the video comments 46. The user is able to view a block option by clicking the followers 112. The system 10 enables the user to click on any of the user name to redirect to their profile 110 page. The system 10 enables logged in user's thumbnail and followers 112 and following count. The system 10 allows the users to create video profile pictures. The video profile pictures are video based. The website is not configured to upload or post any profile pictures. The system 10 allows the user to upload the profile video. To view more video then click on load more 116 to view previous videos 42.

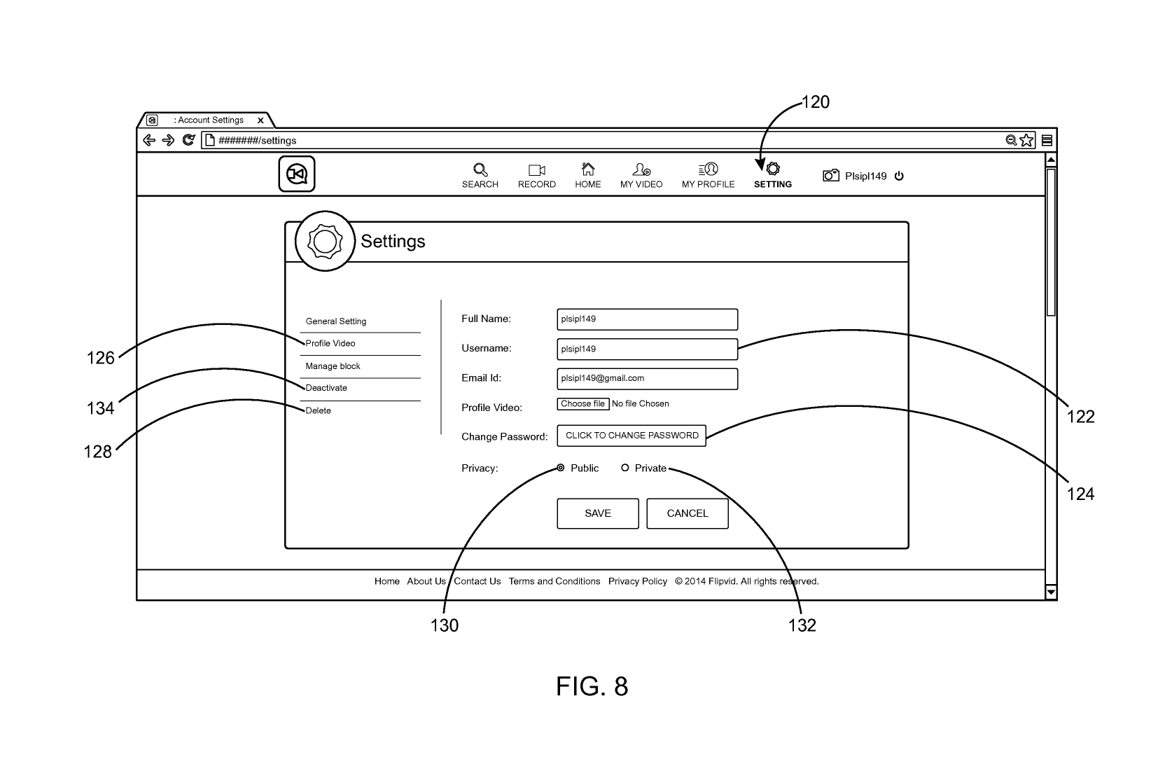

FIG. 8 illustrates a screen shot of a settings 120 tab in accordance with the preferred embodiment of the present invention. The system 10 is configured to change the user name 122 and password 124, and enabled to make profile public 130 from private 132. The system 10 allows the user to delete profile 128 and upload new picture. The system 10 is configured to change password 124. The setting page 120 includes a public 130 module and a private 132 module which allows the user to access the profile in public/private mode respectively. The system 10 allows the user to deactivate 134 the account by selecting delete 128 option to “deactivate account”. The spam function allows the users to report/spam the at least one video 42 and would be automatically deleted from the network 18.

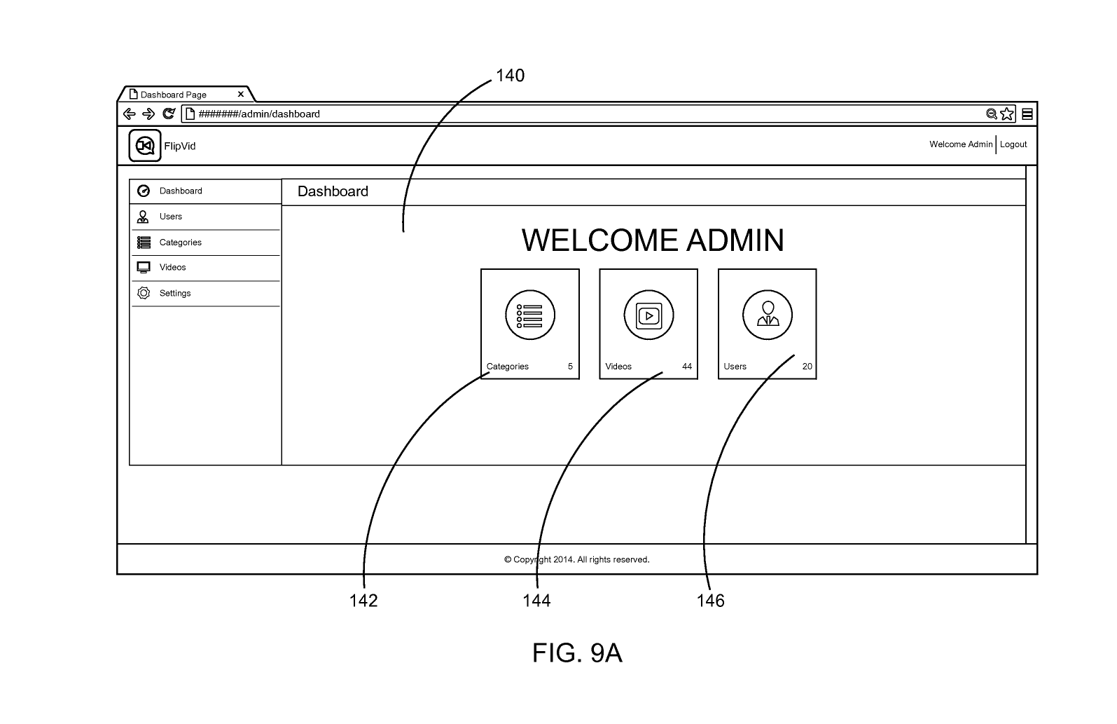

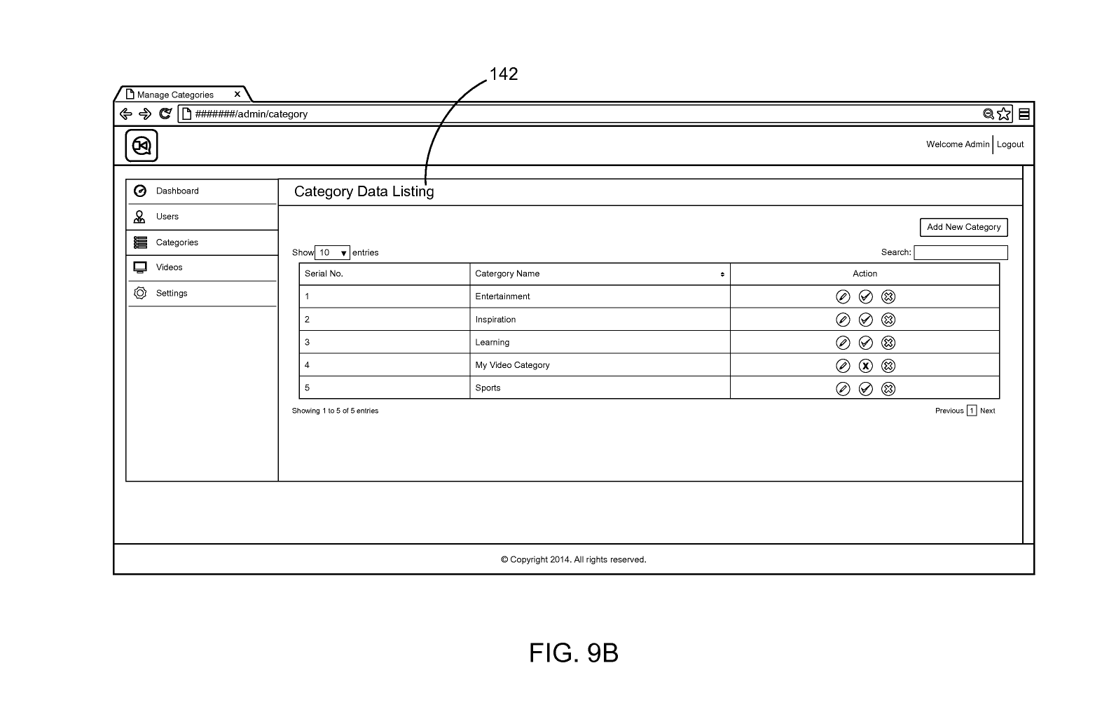

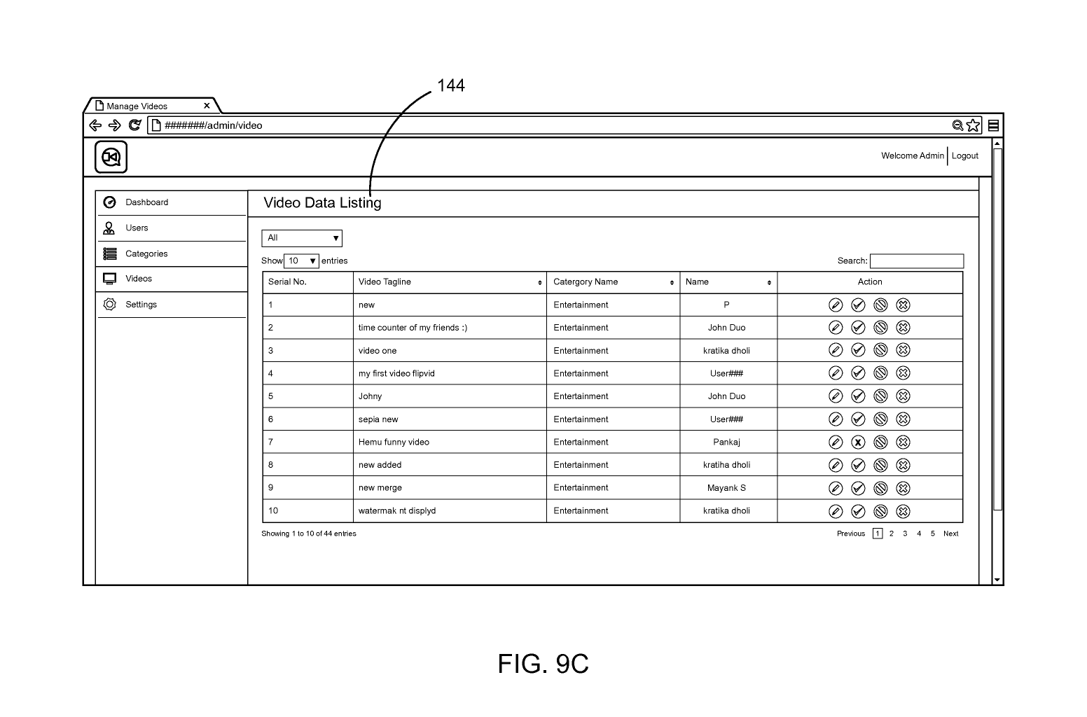

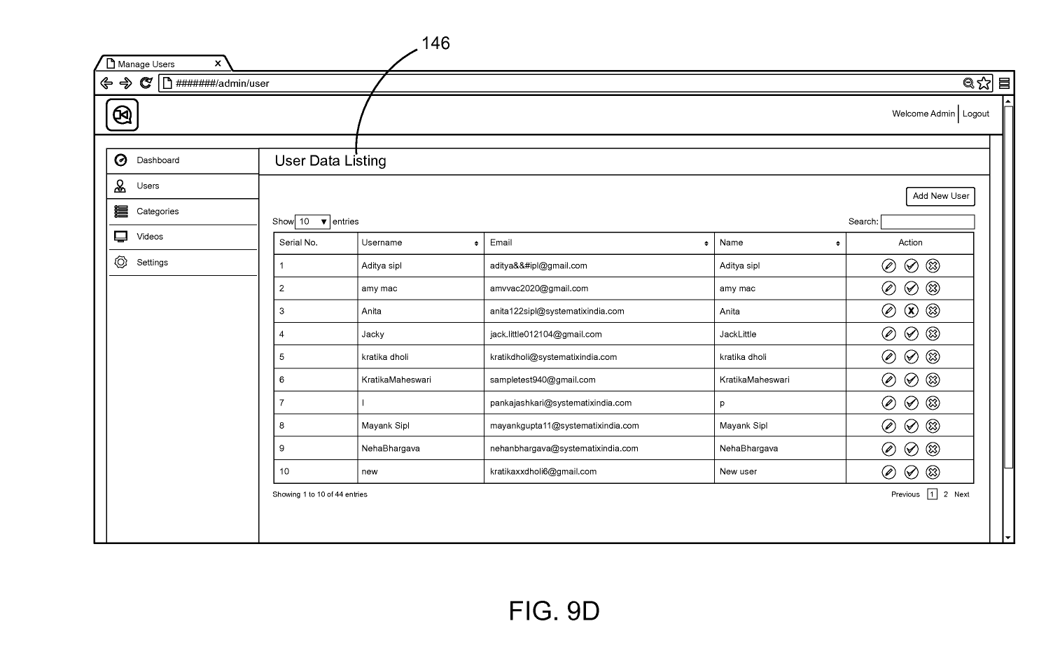

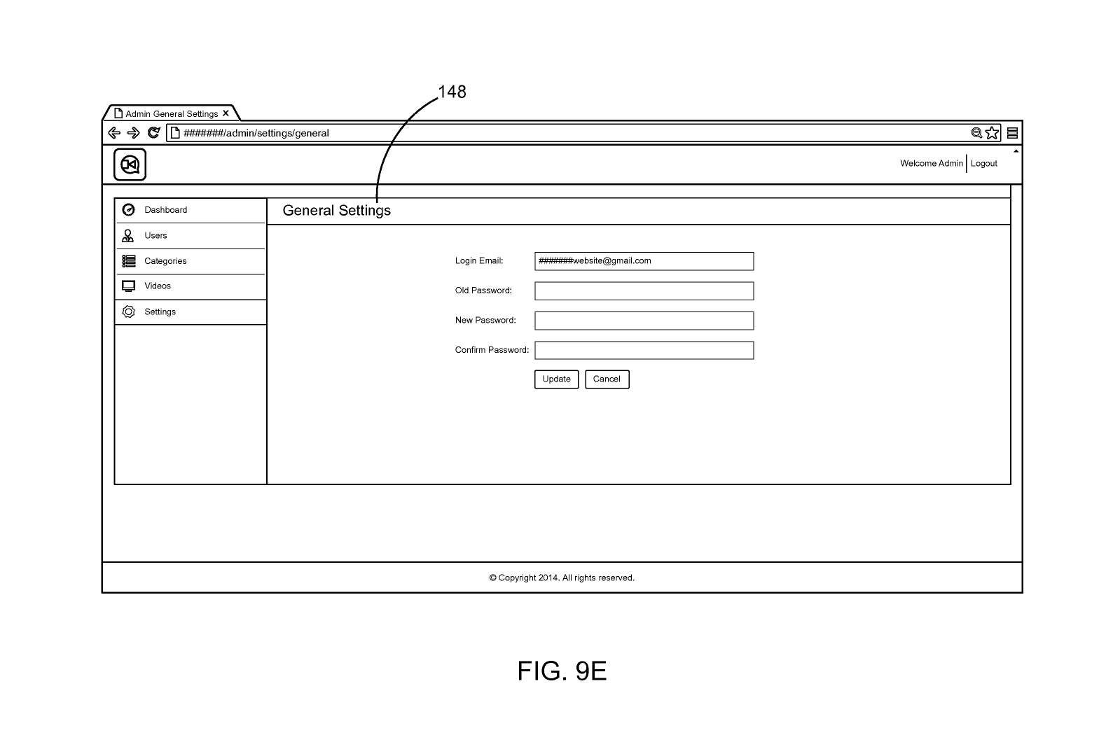

FIGS. 9A through 9E illustrate screen shots of an administrator 140 user in accordance with the preferred embodiment of the present invention. The administrator 140 is an operator of the web based interface 20. The system 10 allows an administrator 140 to view all registered users and their details, or can ban. After logged on to the dashboard the user can access modules to various details and operations of the web based interface 20. These details and operations may be selected from the options categories 142, a user 146, video 144, and settings 148. The administrator 140 allows the user to select the category 142 such as, sports, entertainment etc according to the user's desire. The administrator 140 allows the user to select an option to add category 142 such as name, update details, and delete. The admin can edit/deactivate the category. The search bar allows the user to select the category name.

Further, the user can select an option to perform the system 10 such as, update the category of the video, deactivate, block, activate, search, view details and lot permissions. Furthermore, the manage details allows the user to enable a category 142 and latest likes or comment. The administrator 140 can view the at least one video 42 and update or delete the at least one video 42. The system 10 allows the user to upload video max ten MB only, Any video edited in the website will provided with the watermark of the website. Integration of video player or html5 video tag depending on mimetypes. The system 10 is configured with setting 148 that allows the users to change old password and update new password.

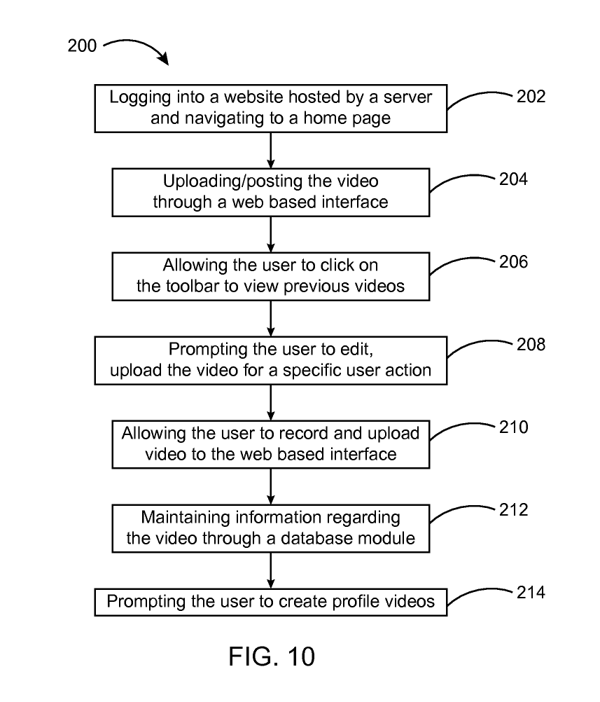

FIG. 10 shows a flowchart of a method 200 for allowing the user actively manage a video in accordance with a preferred embodiment of the present invention. Initially, the user logs into a website hosted by a server and navigates to a home page as indicated at block 202. The user is able to upload/post video through a web based interface as indicated at block 204. The user is allowed to click on a toolbar to view previous videos as indicated at block 206. The system 10 prompts the user to edit/upload the video for a specific user action as indicated at block 208. The user is allowed to record and upload videos and video comments to the website as indicated at block 210. The information regarding the video is maintained in the system within a database module as indicated at block 212. Finally, the web based interface allows the user to create profile videos as indicated at block 214. The web based interface being utilized is selected from the group consisting of: a personal computer, a desktop computer, a laptop computer, a pad or tablet computer, and a smart phone. The method allows the user to view all the video in a home page that includes a toolbar having options to search, record, my video, my profile, and settings.

While a particular form of the invention has been illustrated and described, it will be apparent that various modifications can be made without departing from the spirit and scope of the invention. For example, the system 10 can be configured to include a module for recording videos for an extended period of time. Accordingly, it is not intended that the invention be limited, except as by the appended claims.

What is claimed is:

1. A system for allowing a user to post a video accompanying video comments comprising;
a server coupled with a memory unit integrated with a database module, the database modulo maintains the information regarding at least one video created by the user; and
a web based interface that allows the users to interact with the video, the web based interface maintains a login account and a profile video created by the user;
whereby the system allows the user to record and upload the video to the server utilizing web based interface.

2. The system of claim 1 wherein the system allows the user to flip the camera from a front view to a back view while recording, and turn a light on/off while recording.

3. The system of claim 1 wherein the database module maintains the information regarding video created by users in sync with the web based interface.

4. The system, of claim 1 wherein the system allows the user to edit and upload the video.

5. The system of claim 1 wherein the system being configured with a home page that facilitates the user to view the video in a home page that includes a toolbar having options to search, record, my video, my profile, and settings.

6. The system of claim 1 wherein the system allows the user to view at least one video in the homepage.

7. The system of claim 1 wherein the system being utilized may be selected from the group consisting of: a personal computer, a desktop computer, a laptop computer, a pad or tablet computer, and a smart phone.

8. A method for allowing a user to manage a video comprising:
logging into a website hosted by a server and navigating to a home page;
uploading/posting the video through a web based interface;
allowing the user to click on the toolbar to view previous videos;
prompting the user to edit, upload the video for a specific user action;
allowing the user to record and upload video to the web based interface;
maintaining information regarding the video through a database module; and
prompting the user to create profile videos.

9. The method of claim 8 wherein the web based interface being utilized selected from the group consisting of: a personal computer, a desktop computer a laptop computer, a pad or tablet computer, and a smart phone.

10. The method of claim 8 wherein the method allows the user to view all the video in a home page that includes a toolbar having options to search, record, my video, my profile, and settings.

11. A non-transitory computer storage medium having instructions that, when executed by a system, cause the system to perform operations comprising:
a) logging into website hosted by a server and navigating to a home page;
b) uploading/posting the video through a web based interface;
c) allowing the user to click on the toolbar to view previous videos;
d) prompting the user to edit, upload the video for a specific user action;
e) allowing a user to record and upload video to the web based interface;
f) maintaining information regarding the video through a database module; and
h) prompting the user to create profile videos.

12. The non-transitory computer storage medium of claim 12 wherein the system allows the user to flip the camera from a front view to a back view and turn a light on/off while recording.

13. The non-transitory computer storage medium of claim 12 wherein the system allows the user to view at least one video in a home page that includes a toolbar having options to search, record, my video, my profile, and settings.

14. The non-transitory computer storage medium of claim 12 wherein the web based. interface being utilized selected from the group consisting of: a personal computer, a desktop computer, a laptop computer, a pad or tablet computer, and a smart phone.
